(19) United States
(12) Patent Application Publication
(10) Pub. No.: US 2010/0031057 A1
(43) Pub. Date: Feb. 4, 2010

(54) Traffic analysis resistant storage encryption using implicit and explicit data

(75) Inventors: Donald Rozinak Beaver, Pittsburgh, PA (US); Laszlo Hars, Cranberry Twp, PA (US)

Correspondence Address: SEAGATE TECHNOLOGY LLC;C/O WESTMAN, CHAMPLIN & KELLY, P.A., SUITE 1400, 900 SECOND AVENUE SOUTH, MINNEAPOLIS, MN, 55402-3244, US

(73) Assignee: Seagate Technology LLC

(21) Appl. No.: 12/012,262

(22) Filed: Feb. 1, 2008

(51) Int. Cl. G06F 12/14; H04K 1/00

(52) U.S. Cl. 713/193; 380/22; 711/E12.092; 711/E12.001

(57) ABSTRACT

An encryption scheme for mass storage devices employing a tweakable encryption scheme to add variability to the encrypted data to resist attacks by traffic analysis. Explicit tweak and implicit tweak may be used to add variability to plaintext prior to encryption and eventual storage. The tweak information is either stored on the storage device along with the encrypted data as in the case of an explicit tweak, or it is derived from another source when needed as in the case of an implicit tweak. The ciphertext is decrypted using either the stored explicit tweak value or derive the implicit tweak value to “de-tweak” the decrypted data prior to usage. The data may be deleted by destroying the cipher key(s) to render the ciphertext useless. The tweak information alone is useless for decryption, as the ciphertext needs to be decrypted with the cipher key(s).

### FIELD OF INVENTION

This invention relates to mass storage devices, and in particular relates to cryptographic schemes for mass storage devices to protect content against unwanted security attacks.

### BACKGROUND OF THE INVENTION

The amount of stored electronic data is growing at a rapid pace due to the reliance of modern organizations on electronic transaction and the desire of these organizations to record and organize such transactions into standard electronic format. This growing dependency on stored electronic data also increases its value and attracts unwanted intruders who are motivated to steal or maliciously alter the data while the sensitive data is at rest. As a result, the owners of these sensitive data must find new cost-effective technologies to protect their stored data against security attacks. An accepted approach is to use modern cryptographic technology to transform the original message (plaintext) into encrypted data (ciphertext) prior to storage, transmission, or usage. However, choosing the right encryption technology (the term encryption refers to both encryption and decryption) requires striking the right balance between finding a comfortable level of security and ensuring consistent implementation at a reasonable cost.

General-purpose encryption schemes are designed to broadly protect electronic data against various security problems such as authenticity, confidentiality, and integrity of the data. They also seek to protect data against various strengths of attacks by unwanted intruders.

One such attack is a ciphertext-only attack, in which the attacker obtains one or more encrypted message passively and is challenged to produce the decryption of any one of them. Another attack is a chosen cleartext attack, in which the attacker obtains encryptions of known text of his choice and the attack succeeds if she can subsequently decipher an encryption of an unknown text. In a chosen ciphertext attacks, the attacker have the further ability to obtain decryptions of ciphertext of her choice, and she likewise succeeds if she can subsequently decipher an encryption of an unknown text. Other properties of cryptosystems include non-malleability, namely resistance to alteration of the decrypted cleartext by way of changing the ciphertext.

In network settings, information about the content of the ciphertext can sometimes be inferred by tracking the source and destination of the data, as well as counting how many times parts of the data are repeated. This is known as traffic analysis. A similar kind of inference can be made from cryptosystems in which repetitive data produces repetitive ciphertexts. This attempt is sometimes called a histogram attack.

General-purpose encryption schemes attempt to protect against one or more types of attacks. It is a disadvantage of them in the current setting that the efforts needed to resists strong attacks are unnecessary expenditures when the narrower goal of stored data protection is addressed. For stored data, a more cost-effective encryption scheme should focus on offering protection against ciphertext-only attacks, traffic analysis attacks and histogram attacks.

An appropriate encryption scheme for stored data should also allow the user to access a data segment within a database without having to decrypt the entire database. For example, a conventional encryption method that allows random data access is the block cipher, which takes a specific number of bits and encrypts them all at once. However, a block cipher has a weakness in that it is inherently deterministic where a given unencrypted plaintext and a given key will produce the same ciphertext. As a result, a large plaintext with repeating phrases that uses a block cipher will produce repeatable patterns in its ciphertext. A skilled attacker may gain access to such stored ciphertext and deduce its content through histogram attacks or maliciously change its content through cut-and-paste attacks. To counter these types of attacks, there exist variants of the block cipher that help reduce this deterministic problem by manipulating the input before encryption, the output after encryption or both to maintain ciphertext variability. One such variant is Cipher Block Chaining (CBC) where each block is modified by the previous ciphertext prior to encryption. The drawback to CBC is that the data is not randomly accessible and that the whole chain has to be decrypted before the data can be used. If these chains are short, the processing overhead is lower but larger identical ciphertext blocks might still occur, resulting in the ciphertext being vulnerable to histogram attacks. For stored data, a more suitable encryption scheme should also offer random data accessibility.

With the current popularity of network attached storages and storage area networks, where large databases are divided and stored on multiple storage devices, it is desirable to distribute the cryptographic processing from a central location to the individual storage devices to alleviate potential processing bottlenecks. Therefore, an appropriate encryption scheme for stored data should require low computational overhead so it can be processed by relatively less expensive microprocessors located on the storage devices.

Accordingly, it would be desirable to develop a mass storage device that uses a low-overhead cryptographic technology that protects its stored ciphertext from histogram attacks, traffic analysis attacks and ciphertext-only attacks while allowing random data accessibility.

### SUMMARY OF THE INVENTION

The invention is directed to a novel encryption scheme for mass storage devices, and in particular uses a tweakable encryption scheme to add variability to the encrypted data for protection against histogram attacks and ciphertext-only attacks. The tweakable encryption scheme uses two types of tweaks, the explicit tweak and the implicit tweak, to add variability to the plaintext prior to encryption and eventual storage. The tweak information is either stored on the storage device along with the encrypted data as in the case of an explicit tweak, or it is derived from another source when needed as in the case of an implicit tweak. When the user requests the information, the ciphertext is decrypted using either the stored explicit tweak value or derive the implicit tweak value to “de-tweak” the decrypted data prior to usage. The user can effectively delete the data by destroying the cipher key(s) to render the ciphertext useless. If an attacker manages to read the ciphertext and/or its corresponding tweak information, the attacker cannot derive the plaintext content because the ciphertext is protected against histogram attacks. The tweak information alone is useless for decryption. The ciphertext needs to be decrypted with the cipher key(s).

### BRIEF DESCRIPTION OF THE DRAWINGS

For a fuller understanding of the nature and advantages of the invention, as well as the preferred mode of use, reference should be made to the following detailed description read in conjunction with the accompanying drawings. In the following drawings, like reference numerals designate like or similar parts throughout the drawings.

FIG. 1 is a block diagram of an example networked servers and computing devices that can use a method for traffic analysis resistant storage encryption using implicit and explicit data in accordance with this invention.

FIG. 2 is a pictorial representation of a disk drive that can employ a method for traffic analysis resistant storage encryption using implicit and explicit data in accordance with the principles of the present invention.

FIG. 3 is a functional diagram of an implicit tweak block cipher encryption process.

FIG. 4 is a functional diagram of an implicit tweak block cipher decryption process.

FIG. 5 is a functional diagram of an explicit appended value block cipher encryption process.

FIG. 6 is a functional diagram of an explicit appended value block cipher decryption process.

FIG. 7 is a functional diagram of an explicit appended private tweak block cipher encryption process.

FIG. 8 is a functional diagram of an explicit appended private tweak block cipher decryption process.

FIG. 9 is a functional diagram of an explicit appended public tweak block cipher encryption process.

FIG. 10 is a functional diagram of an explicit appended public tweak block cipher decryption process.

FIG. 11 is a flow chart of an implicit tweak block cipher encryption process.

FIG. 12 is a flow chart of an implicit tweak block cipher decryption process.

FIG. 13 is a flow chart of an explicit appended value block cipher encryption process.

FIG. 14 is a flow chart of an explicit appended private value block cipher decryption process.

FIG. 15 is a flow chart of an explicit appended private tweak value block cipher encryption process.

FIG. 16 is a flow chart of an explicit appended private tweak value block cipher decryption process.

FIG. 17 is a flow chart of an explicit appended public tweak value block cipher encryption process.

FIG. 18 is a flow chart of an explicit appended public tweak value block cipher decryption process.

### DETAILED DESCRIPTION

The present description is of the best presently contemplated mode of carrying out the invention. This description is made for the purpose of illustrating the general principles of the invention and should not be taken in a limiting sense. The scope of the invention is best determined by reference to the appended claims. This invention has been described herein in reference to various embodiments and drawings. It will be appreciated by those skilled in the art that variations and improvements may be accomplished in view of these teachings without deviating from the scope and spirit of the invention.

The present invention is directed to a mass storage device that uses a tweakable encryption scheme to add variability to its encrypted data for enhanced protection against histogram attack and ciphertext-only attacks. As will be detailed below, the encryption scheme uses two types of tweaks: an explicit tweak that is stored on the storage device along with the encrypted data, and/or an implicit tweak that may not be stored on the storage device and may be derived from another source. When the storage device receives new data, it will use a tweak to add variability to the plaintext prior to data encryption. The ciphertext is then stored on the storage device. When the user requests the information, the storage device will read the ciphertext and use a cipher key to decrypt the data. It will then use either the stored explicit tweak value or the derived implicit tweak value to “de-tweak” the data prior to usage. The tweak is not a cipher key. The role of the cipher key is to provide uncertainty while the role of the tweak is to provide independent variability to the attacker. In addition, resources that are needed to change the tweak should be less than resources that are needed to change the cipher key. The tweakable encryption scheme can be implemented either as a tweakable block cipher or a tweakable stream cipher.

By way of illustration and not limitation, the present invention will be described in connection with a magnetic disk drive system that uses a tweakable encryption scheme, and in particular a disk drive system that has an onboard processor or controller that handles the cryptographic process. It will be appreciated that process of the invention may also be supported by one or more general purpose or application specific processors, controller card, an information processing system such as a computer or a server.

It is well contemplated that the novel encryption scheme of the present invention may be applied to other types of data storage systems, such as optical drives, high density floppy disk (HiFD) drives, etc., which may comprise alternative or in addition to magnetic data recording, other forms of data reading and writing, such as magneto-optical recording system, without departing from the scope and spirit of the present invention.

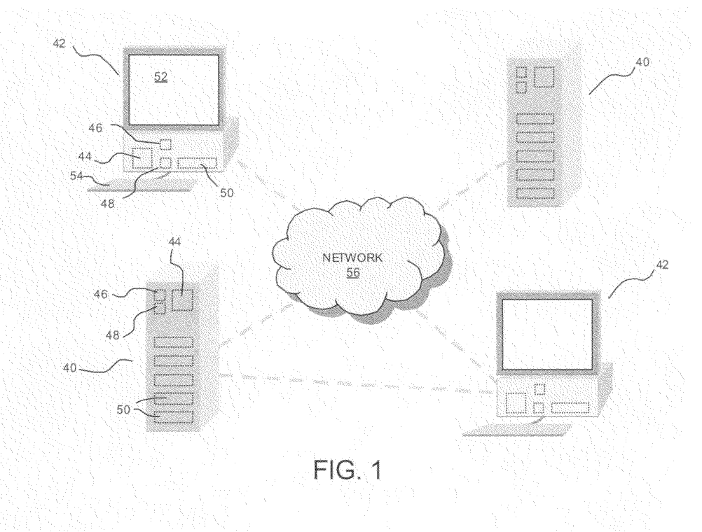

FIG. 1 is a block diagram of an exemplary networked server 40 or computing device 42 that can use tweakable cryptographic scheme in accordance with this invention. A server 40 or computing device 42 is comprised of a processor 44, a volatile memory unit 46, a nonvolatile memory unit 48 and a mass storage device 50. The processor 44 is coupled to the volatile memory unit 46 that acts as the system memory. An example of the volatile memory unit 46 is dynamic random access memory (DRAM). The processor 44 is also coupled to the nonvolatile memory unit 48 that is used to hold an initial set of instructions such as the system firmware. The processor 44 is coupled to the mass storage device 50 that can be used to store data files and instruction sets such as the operating system. The mass storage device 50 can be of any type or combination of types of a magnetic disk drive, a compact disk (CD) drive, a digital video disk (DVD) drive, a floppy disk drive, a Zip drive, a SuperDisk drive, a Magneto-Optical disk drive, a Jazz drive, a high density floppy disk (HiFD) drive, flash memory, read only memory (ROM), programmable read only memory (PROM), erasable programmable read only memory (EPROM), or electrically erasable programmable read only memory (EEPROM). The server 40 or computing device 42 may also include a video output device 52 such as a flat panel monitor to display information to the user, and an input device 54 such as a keyboard or a tablet to accept inputs from the user. The server 40 or computing device 42 may comprise of several processors 44, volatile memory units 46, nonvolatile memory units 48 and mass storage devices 50 each residing in different physical locations and are interconnected via a network 56 without departing from the scope of the present invention.

The server 40 or computing device 42 may be coupled to other computing devices via a network 56. As used in the context of the present invention, a distributed information exchange networks, such as public and private computer networks (e.g., Internet, Intranet, WAN, LAN, etc.), value-added networks, communications networks (e.g., wired or wireless networks), broadcast networks, and a homogeneous or heterogeneous combination of such networks. As will be appreciated by those skilled in the art, the networks include both hardware and software and can be viewed as either, or both, according to which description is most helpful for a particular purpose. For example, the network can be described as a set of hardware nodes that can be interconnected by a communications facility, or alternatively, as the communications facility, or alternatively, as the communications facility itself with or without the nodes.

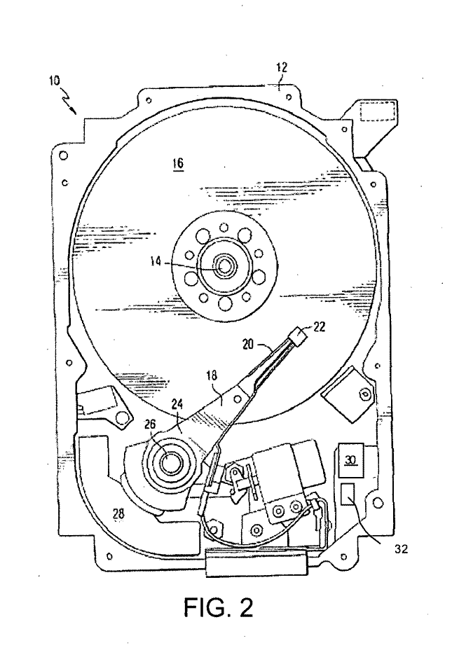

FIG. 2 is an illustration of an example disk drive 10 that can be implemented with the tweakable encryption scheme in accordance with this invention. The disk drive 10 includes a housing 12 (with the upper portion removed and the lower portion visible in this view) sized and configured to contain the various components of the disk drive. The disk drive 10 includes a spindle motor 14 for rotating at least one magnetic storage medium 16, which may be a magnetic recording medium, within the housing, in this case a magnetic disk. A suspension assembly having at least one arm 18 is contained within the housing 12, with each arm 18 having a first end 20 with a transducer in the form of a recording head supported by a slider 22, and a second end 24 pivotally mounted on a shaft by a bearing 26. An actuator motor 28 is located at the arm's second end 24 for pivoting the arm 18 to position the recording head 22 over a desired sector or track of the disk 16. The actuator motor 28 and other components are regulated by a controller 30 which may also be implemented with the tweakable encryption scheme in accordance with the disclosure below. Part or all of the encryption and decryption processes may be handled by a separate microchip 32 located on the disk drive, or in the host system to which the disk drive is associated or coupled.

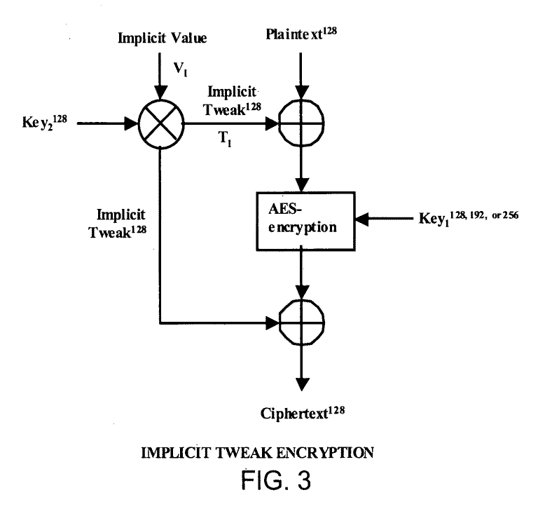

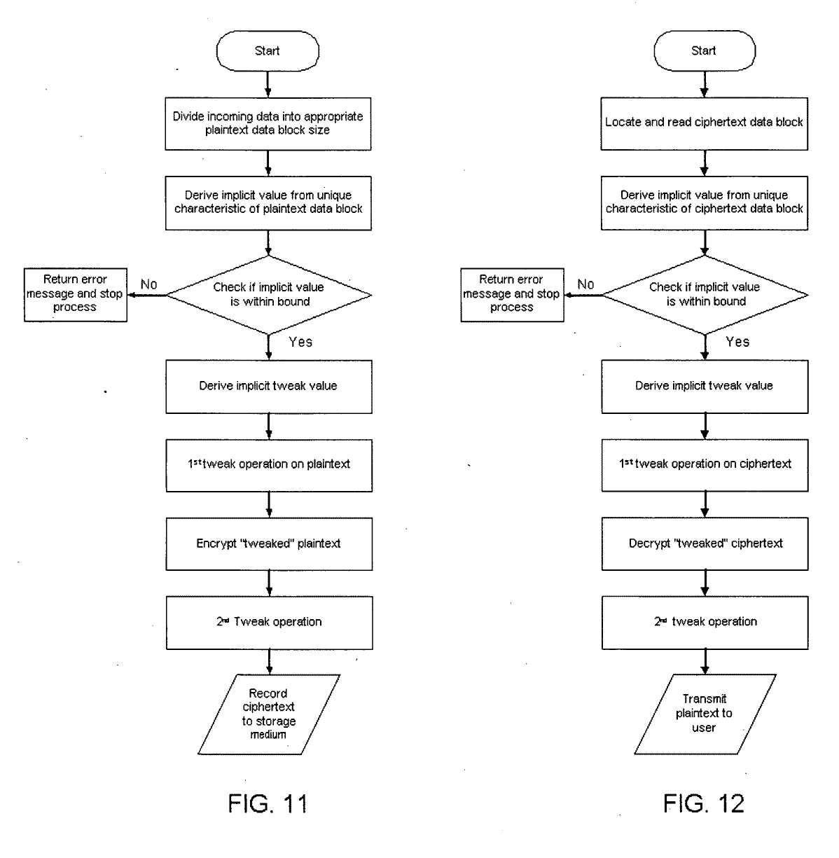

FIGS. 3 & 11 refer to an embodiment of the invention that uses an implicit tweak block cipher for encryption. FIG. 11 is a flow chart of this embodiment when used in encryption mode. The initial setup requires choosing two independent keys: Key₁ and Key₂ where Key₁ is the cipher key and Key₂ is the tweak key. Key₁ needs to be selected by a known process in accordance with Advanced Encryption Standard (AES) key generation and can be 128, 192 or 256 bits long. Key₂ is a randomly chosen nonzero value that is 128 bits long and must be protected throughout the life of the stored encrypted data.

When the storage device receives a data stream, it divides the incoming data into sectors that are 512 bytes long. These data sectors are further divided into 32 plaintext blocks that are each 128 bits long. An implicit value (V₁) is derived from a preferably non-repeating, characteristic of the data such as its Logical Block Address, its actual physical address of the data, or its cylinder/head/sector information. These derivations are by a known process in the art that ensures that the implicit value is non-zero and is less than 2¹²⁸−1. Upon verification that the implicit value is non-zero and is less than 2¹²⁸−1, an implicit tweak value (T₁) is calculated that is 128 bits long by performing modular multiplication on Key₂ and the implicit value. The T₁ value for each data block should also be non-repeating since it is derived from a non-repeating implicit value.

Variability is added to the data by performing an XOR operation between the plaintext block and the T₁ value. The resulting value from the XOR operation is then encrypted using Key₁ and AES encryption to add security to the data. An XOR operation is again performed between the T₁ value and the result of the AES encryption to produce the ciphertext. The V₁ and T₁ values are discarded while the ciphertext is recorded to the storage medium on the storage device.

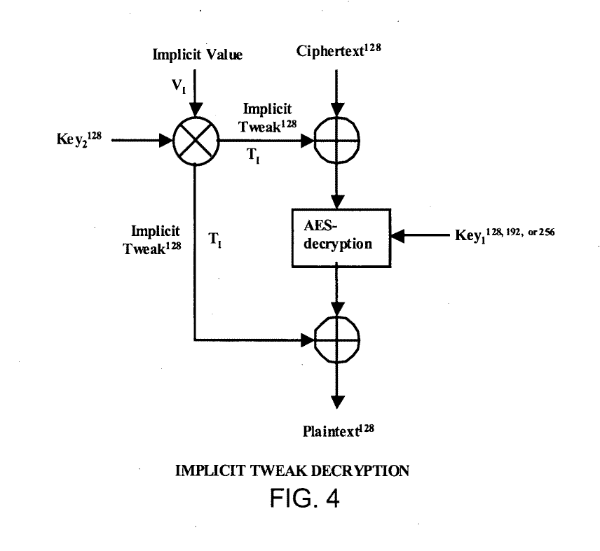

FIGS. 4 & 12 refer to an embodiment of the invention for decryption of encrypted data from an implicit tweak block cipher. FIG. 12 is a flow chart of this embodiment when used in decryption mode. When the user wants to use the stored data, the storage device locates and reads the appropriate ciphertext. It will retrieve the same unique characteristic of the data block that was used for the encryption process and derive the implicit value using a known process in the art from this characteristic. Upon verification that the derived implicit value is non-zero and is less than 2128-1, the modular multiplication is performed using V₁ and Key₂ to derive the T₁ value. An XOR operation is performed between the ciphertext and the T₁ value and the result is decrypted using the AES decryption process and decryption Key₁. The plaintext is finally extracted from the AES decryption result by performing an XOR operation between the AES decryption result and T₁ value. The plaintext is then sent to the user.

Further details of the tweakable block cipher encryption and decryption scheme may be referred from the published draft version 1.00:00 of the IEEE standards document edited by C. Kent, “Draft Proposal for Tweakable Narrow-block Encryption”, 2004, and in the technical paper by M. Liskov, R. Rivest, and D. Wagner, “Tweakable Block Ciphers” Advances in Cryptology—CRYPTO 2002, 22^{nd} Annual International Cryptology Conference (2002), which are incorporated by reference as if fully set forth herein.

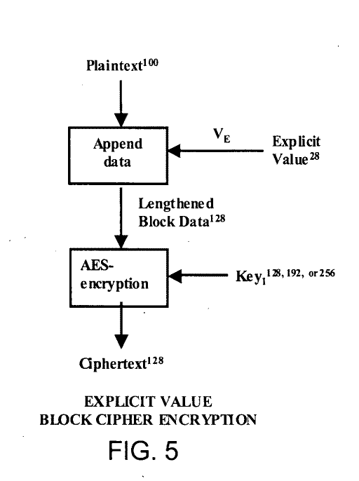

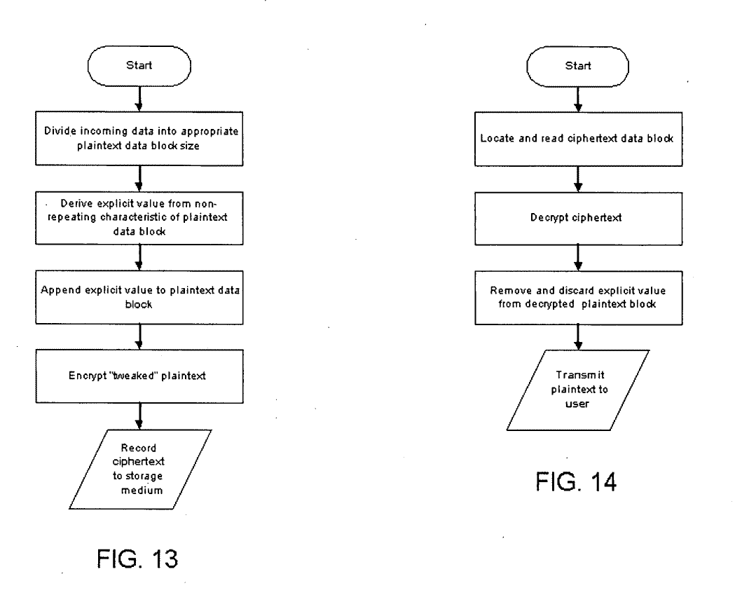

FIGS. 5 & 13 refer to an embodiment of the invention that uses an explicit appended value for encryption. FIG. 13 is a flow chart of this embodiment when used in the encryption mode. The initial setup requires choosing a cipher key Key₁ by a known process that is in accordance with AES key generation and can be 128, 192, or 256 bits long and must be protected throughout the life of the stored encrypted data.

As an illustrative example, when the storage device receives a data stream, it will divide the data stream into plaintext blocks that are 100 bits long. A unique explicit value (V_{E}) is derived using a known process from a value such as a counter, an arbitrary string, or a local servo tracking error correction information, using methods that is known in the art to produce a preferably pseudo-random and non-repeating value that is 28 bits long that should be protected throughout the life of the stored encrypted data. A different V_{E} is appended to each plaintext block to add variability, resulting in a lengthened plaintext block that is 128 bits long. The lengthened plaintext block is then encrypted using Key₁ and AES encryption to produce the ciphertext. The ciphertext is then recorded to the storage medium. Since each block data of ciphertext includes its own encrypted V_{E} value, the ciphertext data block can freely be moved around on the disk (e.g. automatic de-fragmentation).

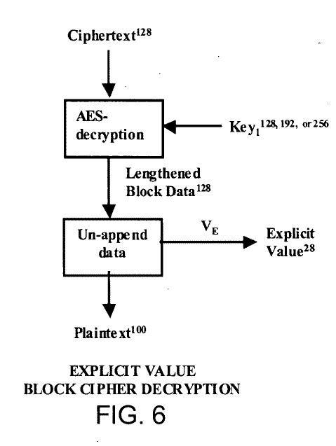

FIGS. 6 & 14 refer to an embodiment of the invention for decryption of encrypted data from an explicit appended value. FIG. 14 is a flow chart of this embodiment when used in decryption mode. When the user wants to use the stored ciphertext data, the storage device locates and read the ciphertext. It then decrypts the ciphertext using the AES decryption scheme and Key₁ to reveal the lengthened plaintext block. The V_{E} value located in the lengthened plaintext block and is stripped away from the AES decryption results to reveal the original message.

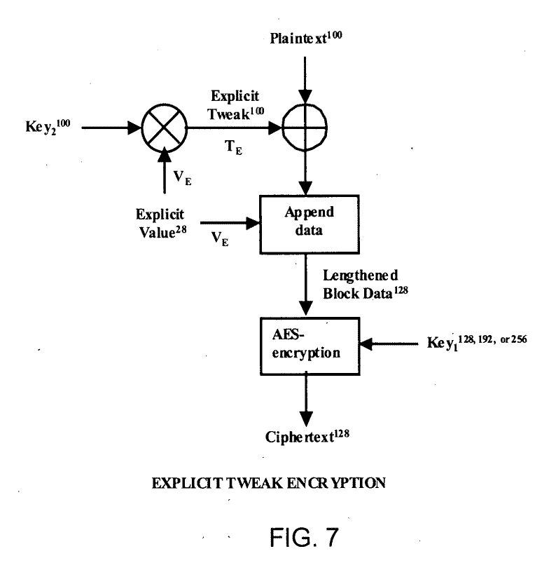

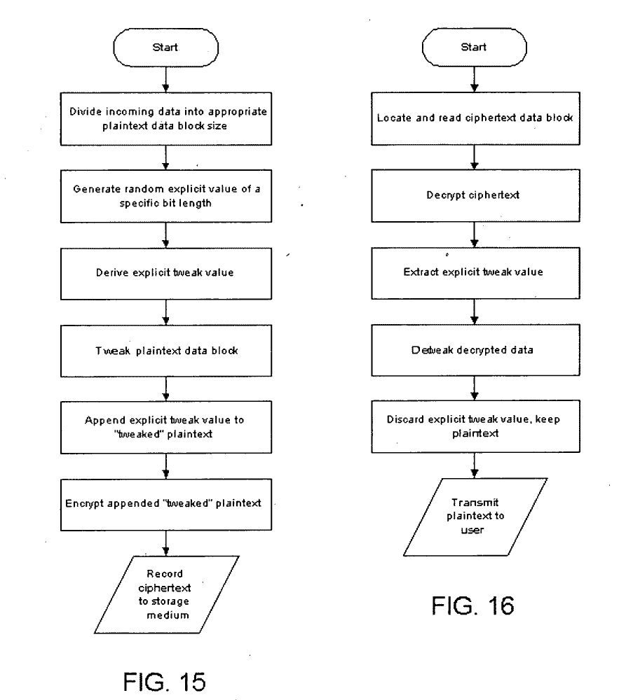

FIGS. 7 & 15 refer to an embodiment of the invention that uses an explicit appended private tweak block cipher. FIG. 15 is a flow chart of this embodiment when used in the encryption mode. The initial setup requires choosing two independent keys: Key₁ and Key₂ where Key₁ is the cipher key and Key₂ is the tweak key. Key₁ needs to be selected by a known process in accordance with AES key generation and can be 128, 192, or 256 bits long. Key₂ is a randomly chosen nonzero value that is 100 bits long and must be protected throughout the life of the stored encrypted data.

When the storage device receives a data stream, it will divide the data stream into plaintext blocks that are 100 bits long. An explicit tweak value (V_{E}) value is then derived using a known process to create a random non-zero value that is 28 bits long. An explicit tweak value (T_{E}) is calculated which is also 100 bits long by performing modular multiplication on Key₂ and the V_{E} value.

Variability is added to the data by performing an XOR operation between the plaintext block and T_{E}. The 28 bits V_{E} value is appended to the 100 bits result from the XOR operation to create a 128 bits long data block. The T_{E} value, on the other hand, is discarded. The lengthened data block is then encrypted using Key₁ and AES encryption to add security to the data. The resulting ciphertext is then recorded to the storage medium on the storage device.

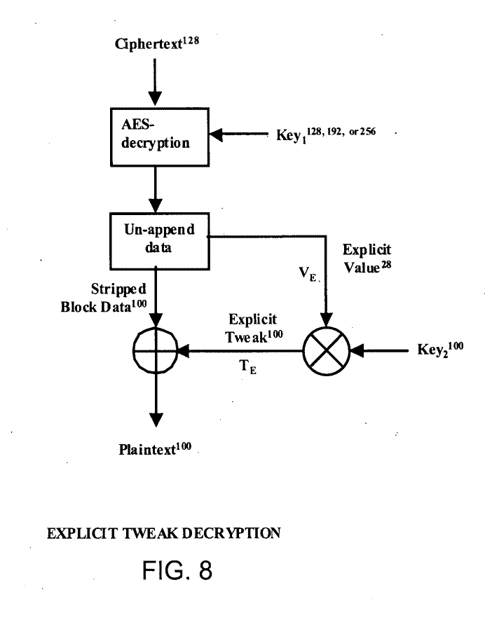

FIGS. 8 & 16 refer to an embodiment of the invention for decryption of encrypted data from an explicit appended private tweak block cipher. FIG. 16 is a flow chart of this embodiment when used in decryption mode. When the user wants to use the data, the storage device reads the ciphertext and decrypts it using the AES decryption process and Key₁ that was used for encryption. The V_{E} value is stripped away from the decrypted data block and it is used to compute the T_{E} value by performing modular multiplication between the V_{E} value and Key₂. An XOR operation is performed between the stripped data block and T_{E} to reveal the plaintext. The plaintext is then sent to the user for processing.

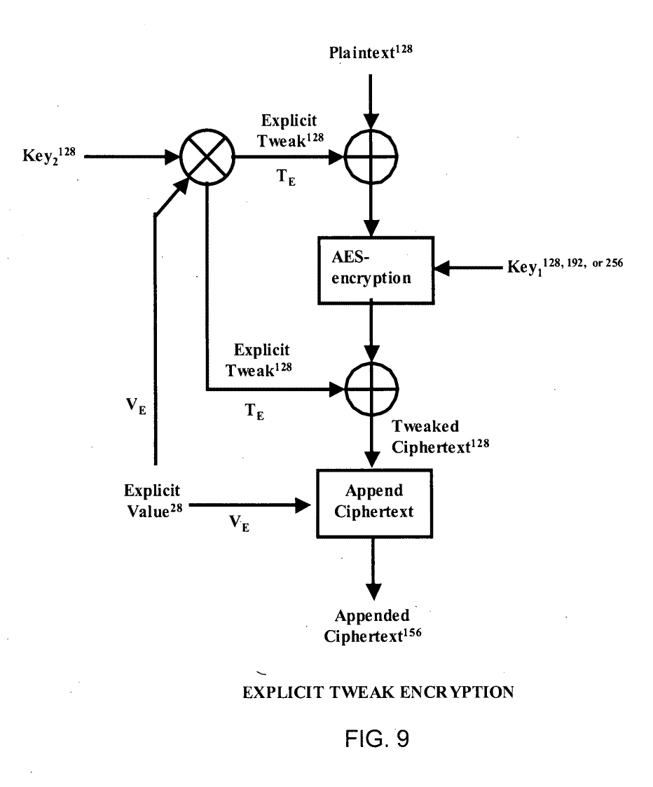

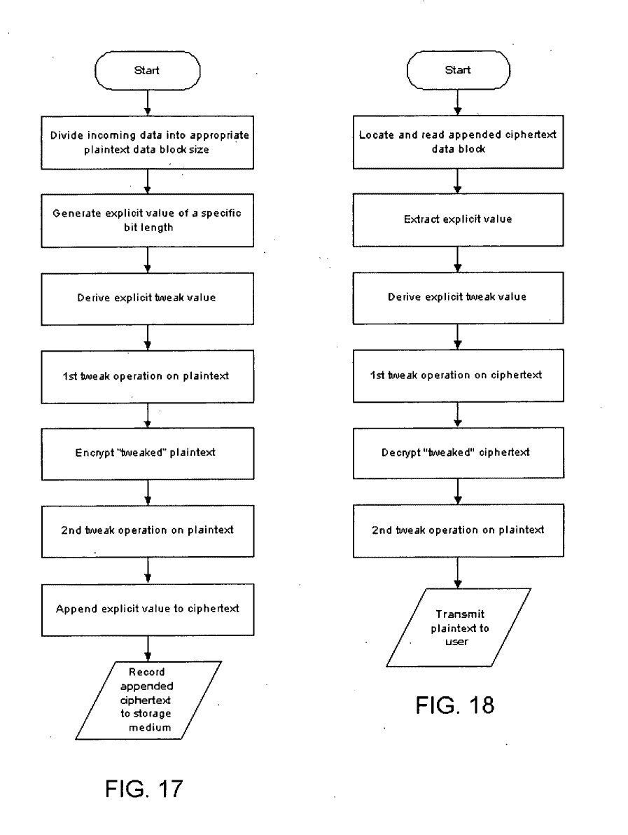

FIGS. 9 & 17 refer to an embodiment of the invention that uses an explicit appended public tweak block cipher. FIG. 17 is a flow chart of this embodiment when used in the encryption mode. The initial setup once again requires choosing two independent keys: Key₁ and Key₂ where Key₁ is the cipher key and Key₂ is the tweak key. Key₁ needs to be selected by a known process in accordance with AES key generation and can be 128, 192, or 256 bits long. Key₂ is a randomly chosen nonzero value that is 128 bits long and must be protected throughout the life of the stored encrypted data.

When the storage device receives a data stream, it divides the data stream into plaintext blocks that are 128 bits long. A unique explicit appended value (V_{E}) is then derived using a known process to create a random non-zero value that is 28 bits long. Modular multiplication is performed using the Key₂ and V_{E} values to create a tweak value (T_{E}) that is 128 bits long.

Variability is added to the data by performing an XOR operation between the plaintext block and T_{E}. The tweaked data block is then encrypted using Key₁ and AES encryption to add security to the data. An XOR operation is again performed between the T_{E} value and the encrypted data to produce a 128 bits tweaked ciphertext. The 28 bits V_{E} value is then appended to the tweaked ciphertext to create a 156 bits appended ciphertext. The T_{E} value, on the other hand, is discarded. The 156 bits appended ciphertext is then recorded to the storage medium on the storage device.

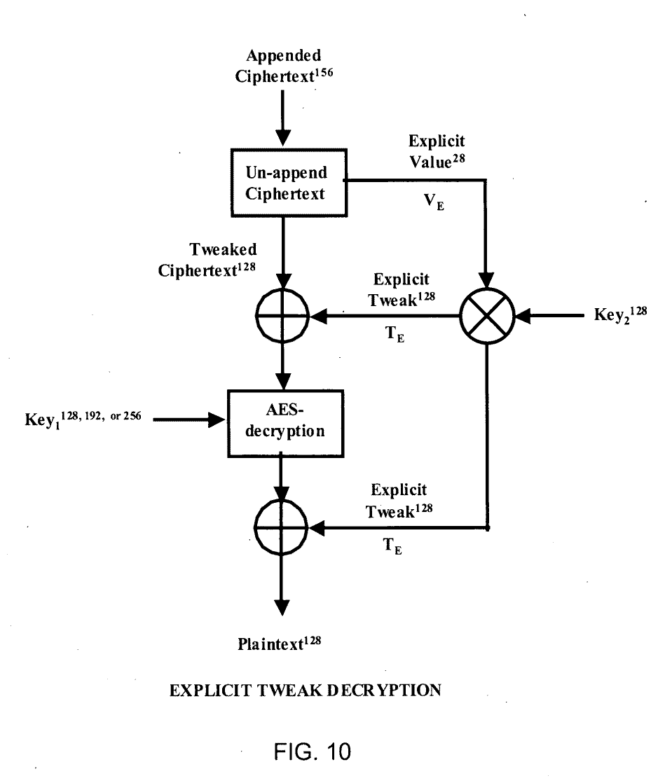

FIGS. 10 & 18 refer to an embodiment of the invention for decryption of encrypted data from an explicit appended private tweak block cipher. FIG. 18 is a flow chart of this embodiment when used in decryption mode. When the user wants to use the data, the storage device reads the 156 bits appended ciphertext. The 28 bits V_{E} value is stripped away from the data block leaving behind the 128 bits ciphertext. Modular multiplication is performed between the V_{E} value and Key₂ to generate a T_{E} value. An XOR operation is performed between the T_{E} value and the 128 bits un-appended ciphertext. The result from this operation is then decrypted using the AES decryption process and Key₁ that was used for the encryption process. A second XOR operation is performed between the decrypted results and the T_{E} to reveal the 128 bits plaintext. The plaintext is then sent to the user for processing.

Using a tweakable encryption scheme on a storage device, for example a magnetic storage device, is useful not only for hiding the data from prying eyes, but also for making the ciphertext quickly inaccessible by simply destroying the encryption key instead of deleting the significantly larger ciphertext. A conventional method to securely delete a file is to overwrite 0's and 1's over the entire data file to remove any magnetic remnants of the ciphertext or certain series of bit patterns and/or random data. These methods are time consuming especially for large data files because the data erase application must write 0's and 1's many times to ensure that the ciphertext cannot be recovered from residual magnetic information on the disk platters. On the other hand, simply destroying the encryption key does not result in secure deletion because the ciphertext may still remain on the storage medium as magnetic remnants until it is overwritten. A skilled attacker may gain access to the ciphertext before it is overwritten and use histogram attacks to deduce some information of the ciphertext. A tweakable encryption scheme adds variability into the ciphertext so that no discernable pattern appears in the ciphertext and between ciphertexts and thus, preventing a skilled intruder from using histogram attacks to deduce information from the magnetic remnants of the ciphertext. Even if the implicit or explicit value used to calculate the tweak value falls into the hand of an intruder, it will not compromise the security of the encryption scheme since the process used to generate the tweak value is separated from the encryption scheme. Therefore, the user can safely “shred” the stored ciphertext by simply locating and destroying the appropriate cipher key(s).

The processes and associated steps discussed above for the various embodiments may be implemented in part or in whole by hardware, firmware and/or software located in the data storage system, such as on board the controller of the disk drive itself. Part or all of the hardware, firmware and/or software supporting the encryption/decryption function and process may be located outside the drive in the associated host system.

Even though particular embodiments use a symmetric key system where the encrypting and decrypting process uses similar keys, it will be appreciated by those skilled in the art that the invention may also use an asymmetric key system, use a family of secret keys or that a family of secret keys may be derived from one or more master keys. In addition, the invention may use another encryption scheme besides AES such as Data Encryption Standard (DES) or triple DES to add uncertainty to the ciphertext. It may also use an implicit tweak in combination with an explicit tweak to add variability to the ciphertext.

Although the described embodiments use a tweakable block cipher encryption scheme that works on data blocks that are 128 bits long, it will be appreciated by those of ordinary skill in the art that the process can be adapted to work on data blocks of larger lengths such as 256 bits or 4096 bits. It will also be appreciated by those skilled in the art that the process can be adapted to become a tweakable stream cipher scheme where the plaintext is enciphered bit by bit. For example, a tweakable encryption scheme may use an addressable pseudorandom sequence, also known as a pseudorandom function. In this more specific situation, it is not necessary to calculate the entire initial sequence of bits in order to obtain later bits in the sequence. In other words, the stream is random accessible. A tweak can be used to alter the stream inside well-defined windows. For example, a tweakable stream encryption scheme applied to plaintext could be produced by performing an XOR operation between f(T,n) with the plaintext, where n describes a location in the stream, T is a tweak value and f(T,n) is a pseudorandom function that produces, for example, a 512 byte outputs.

Even though the embodiments describe a storage device that encrypts the data prior to storage and decrypts the data prior to transmission, it can be appreciated by those skilled in the art that the storage device may also receive, store or transmit plaintexts without encryption and that it may receive, store or transmit ciphertexts without decryption, followed by the encryption/decryption schemes of the present invention disclosed herein.

Although some of the embodiments describe a scheme where the explicit value is appended to the ciphertext, the invention may save the explicit value in another secured part of the storage medium that is not made accessible outside the drive instead of appending it to the ciphertext. Similarly, some of the embodiments describe using implicit values that are derived from logical or physical location values of the data blocks. It can be appreciated by those skilled in the art that the implicit values may also be derived from non-locational values such as pseudo-random numbers or counter values and that these non-locational values are saved to another secured part of the storage medium that is inaccessible to outsiders.

Even though some of the embodiments use modular multiplication between an explicit or implicit value and a tweak key to alter the pattern in the tweak value, the invention may also use other hash functions that are known in the art to create a non-repeating value of a certain bit length for use as a tweak value. For example, a hash function h_{Key2} (x)=a x+b modulo 2̂128 where Key₂²⁵⁶=(a₁₂₈, b₁₂₈). In this example, Key₂ is 256 bits and the output from h(x) is 128 bits.

A method or process is here, and generally, conceived to be a self-consistent sequence of steps leading to a desired result. These steps require physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities.

Useful devices for performing some of the operations of the present invention include, but is not limited to, general or specific purpose digital processing and/or computing devices, which devices may be standalone devices or part of a larger system. The devices may be selectively activated or reconfigured by a program, routine and/or a sequence of instructions and/or logic stored in one or more of the devices or their components. In short, use of the methods described and suggested herein is not limited to a particular processing configuration.

The process and system of the present invention has been described above in terms of functional modules in block diagram format. It is understood that unless otherwise stated to the contrary herein, one or more functions may be integrated in a single physical device or a software module in a software product, or a function may be implemented in separate physical devices or software modules, without departing from the scope and spirit of the present invention. It will be further appreciated that the line between hardware and software is not always sharp.

It is appreciated that detailed discussion of the actual implementation of each module is not necessary for an enabling understanding of the invention. The actual implementation is well within the routine skill of a programmer and system engineer, given the disclosure herein of the process attributes, functionality and inter-relationship of the various functional steps in the process. A person skilled in the art, applying ordinary skill can practice the present invention without undue experimentation.

While particular embodiments of the invention have been described herein for the purpose of illustrating the invention and not for the purpose of limiting the same, it will be appreciated by those of ordinary skill in the art that numerous variations of the details and arrangements of processing steps may be made without departing from the scope of the invention as defined in the appended claims.

1. A method for providing security of data in a data storage device, comprising data ciphering prior to writing to the storage device, which comprises:
tweaking plaintext of the data to be stored in the storage device to generate tweaked data;
encrypting the tweaked data to generate ciphertext of the data; and
storing the ciphertext in the data storage device.

2. The method of claim 1, further comprising data deciphering after reading from the data storage device, comprising:
decrypting the ciphertext to obtain the tweaked data;
de-tweaking the tweaked data to obtain the plaintext of the data that was stored in the data storage device.

3. The method of claim 1, wherein the tweaking step comprises applying a tweak value to the plaintext to generate the tweaked data.

4. The method of claim 3, wherein the tweak value comprises an explicit tweak value derived from a tweak key and an explicit value.

5. The method of claim 4, wherein the tweaking step comprises applying the explicit tweak value to the plaintext to generate a derived value, and appending the explicit value to the derived value to generate the tweaked data.

6. The method of claim 4, wherein the encrypting step comprises an encryption operation to generate encrypted data, and a tweak operation to tweak the encrypted data to generate tweaked ciphertext.

7. The method of claim 6, wherein the tweak operation is based on a same explicit tweak value previously applied in the tweaking step.

8. The method of claim 7, wherein the encrypting step further comprising appending the explicit value to the tweaked ciphertext to generate the ciphertext to be stored in the data storage device.

9. The method of claim 3, wherein the tweak value comprises an implicit tweak value.

10. The method of claim 9, wherein the encrypting step comprising an encryption operation to generate encrypted data, and a tweak operation to tweak the encrypted data to generate tweaked ciphertext.

11. The method of claim 10, wherein the tweak operation is based on a same implicit tweak value previously applied in the tweaking step.

12. The method of claim 11, wherein the implicit tweak value is derived from a tweak key and an implicit value.

13. The method of claim 3, wherein the tweak value comprises an explicit value, wherein the tweak value is applied to the plaintext by appending the explicit value to the plaintext.

14. The method of claim 1, wherein at least one of tweaking and encrypting is under control by a controller provided within the disk drive.

15. The method as in claim 1, wherein at least one of tweaking and encrypting is under control by a host system.

16. The method as in claim 1, wherein the data storage device comprises a magnetic data storage device.

17. A data storage system, comprising:
a data storage medium;
a transducer reading and writing data with respect to the data storage medium;
a controller providing security of data in a data storage device, including undertaking data ciphering operation prior to writing to the storage device, wherein plaintext of the data is tweak to be stored in the storage device to generate tweaked data, the tweaked data is encrypted to generate ciphertext of the data, and the ciphertext is stored in the data storage device.

18. The data storage system as in claim 17, wherein the controller undertaking data deciphering after reading from the data storage device, wherein the ciphertext is decrypted to obtain the tweaked data, the tweaked data is de-tweaked to obtain the plaintext of the data that was stored in the data storage device.

19. The data storage system as in claim 17, wherein the data storage system comprises a magnetic disk drive.

20. A data processing system, comprising:
a data storage system as in claim 17; and
a host system operatively coupled to the disk drive system, said host system comprising a processor and an operating system, wherein the processor transfers data to and from the disk drive system for read and write operations.
